(19) United States
(12) Patent Application Publication
(10) Pub. No.: US 2026/0072719 A1
(43) Pub. Date: Mar. 12, 2026

(54) SUBSTITUTION-BASED CONTAINER IMAGE LAYER DEPLOYMENT

(71) Applicant: INTERNATIONAL BUSINESS MACHINES CORPORATION, Armonk, NY (US)

(72) Inventors: Kui ZHANG, Tianjin (CN); Jiu Chang DU, Beijing (CN); Lu Yan LI, Beijing (CN); Min CHENG, Beijing (CN); Xiao Ling CHEN, Beijing (CN)

(21) Appl. No.: 18/826,324

(22) Filed: Sep. 6, 2024

(51) Int. Cl. G06F 9/455

(52) U.S. Cl. CPC G06F 9/45529

(57) ABSTRACT

A container image layer deployment process is provided based on layer substitution relationships. The process includes generating layer substitution relationship data for one or more image layers of a container image of a container-based computing environment. The layer substitution relationship data specifies one or more layer substitution relationships between different image layers of the container image. Based on a download request that specifies a target image layer of the container, the process includes identifying an image layer subset that omits one or more superseded image layers of the container image. The identifying is based, at least in part, on the generated layer substitution relationship data or the one or more image layers of the container image. Further, the process includes establishing a container image layer deployment based on the identified image layer subset to facilitate container image processing within the container-based computing environment.

### BACKGROUND

One or more aspects relate, in general, to facilitating processing within a computing environment, and in particular, to enhancing processing within in a container-based computing environment.

As an example, a container-based computing environment, or container-based data processor system, can be an open platform for developing, shipping and running applications in containers. At their core, such systems provide a way to run almost any application securely isolated in a container. By way of example, a container can consist of an application, user added files, and metadata for the application. Each container can be built from a container image, which can specify what the container holds, and what process is to run when the container is launched, and a variety of other configuration data. The container image is typically a read-only template from which the container is launched. The container image can include a series of image layers and be built from one or more base images using a set of instructions, each of which creates a new image layer of the container image.

A container image is generally understood to be an unchangeable, static file that includes executable code so that it can run an isolated process on information technology (IT) infrastructure. The container image can be understood as a special file system. Container images can be utilized to provide various files, including, but limited to, programs, libraries, or resources, and configuration files, which are executed by the container image.

As a further example, containers are often used as a deployment platform for microservices, with a microservice being combined with a container image as a single unit of execution, in one or more implementations. This allows the microservice to embody discrete components of an application, and only provides for the minimum resources needed to perform the particular microservice. Microservices can be used together to create scalable applications. This approach avoids a need to build and deploy new software versions each time a particular function is changed or scaled.

### SUMMARY

Certain shortcomings of the prior art are overcome, and additional advantages are provided herein through the provision of a computer-implemented method which includes generating layer substitution relationship data for one or more image layers of a container image of a container-based computing environment. The layer substitution relationship data specifies one or more layer substitution relationships between different image layers of the container image. Based on a download request that specifies a target image layer of the container, the computer-implemented method further includes identifying an image layer subset that omits one or more superseded image layers of the container image, where the identifying is based, at least in part, on the generated layer substitution relationship data for the one or more image layers of the container image. In addition, the method includes establishing a container image layer deployment based on the identified image layer subset to facilitate container processing within the container-based computing environment.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with container image layer deployment code, in accordance with one or more aspects of the present disclosure;

FIG. 3 depicts one embodiment of a container image layer deployment workflow, in accordance with one or more aspects of the present disclosure;

FIG. 4 depicts one embodiment of a container deployment system to include and/or use one or more aspects of the present disclosure;

FIG. 5 depicts a computing infrastructure implementation of a container deployment system, such as the container deployment system of FIG. 4, in accordance with one or more aspects of the present disclosure;

FIG. 6 depicts another computing infrastructure implementation of a container deployment system, such as the container deployment system of FIG. 4, in accordance with one or more aspects of the present disclosure;

FIG. 7 illustrates one example of multiple image layers of a container union file system and the reducing of image layers for a container image layer deployment using layer substitution data, in accordance with one or more aspects of the present disclosure;

FIG. 8 depicts another embodiment of a container image layer deployment workflow, in accordance with one or more aspects of the present disclosure;

FIG. 9 depicts further details of one embodiment of a container deployment system including and/or using one or more aspects of the present disclosure;

FIGS. 10A-10B depict one detailed embodiment of a substitution-based, container image layer deployment workflow implemented by the container deployment system of FIG. 9, in accordance with one or more aspects of the present disclosure;

FIG. 11 depicts an exemplary layer substitution relationship for use in identifying superseded layers when downloading a container image from a container repository, in accordance with one or more aspects of the present disclosure;

FIG. 12A depicts an exemplary graph for the container image example of FIG. 11, with the new attribute layer substitution list for each node, in combination with the relation ID list of all nodes that have dependencies with the node, in accordance with one or more aspects of the present disclosure;

FIG. 12B depicts the graph of FIG. 12A with exemplary target image layer 5 shown superseded by replacement or superseding layer 6, in accordance with one or more aspects of the present disclosure; and

FIG. 12C depicts one embodiment of a streamlined minimum dependency graph dynamically generated based on the layer substitution lists (and other metadata, for instance, relation ID lists) of the layers during pulling of a container image from the container repository, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

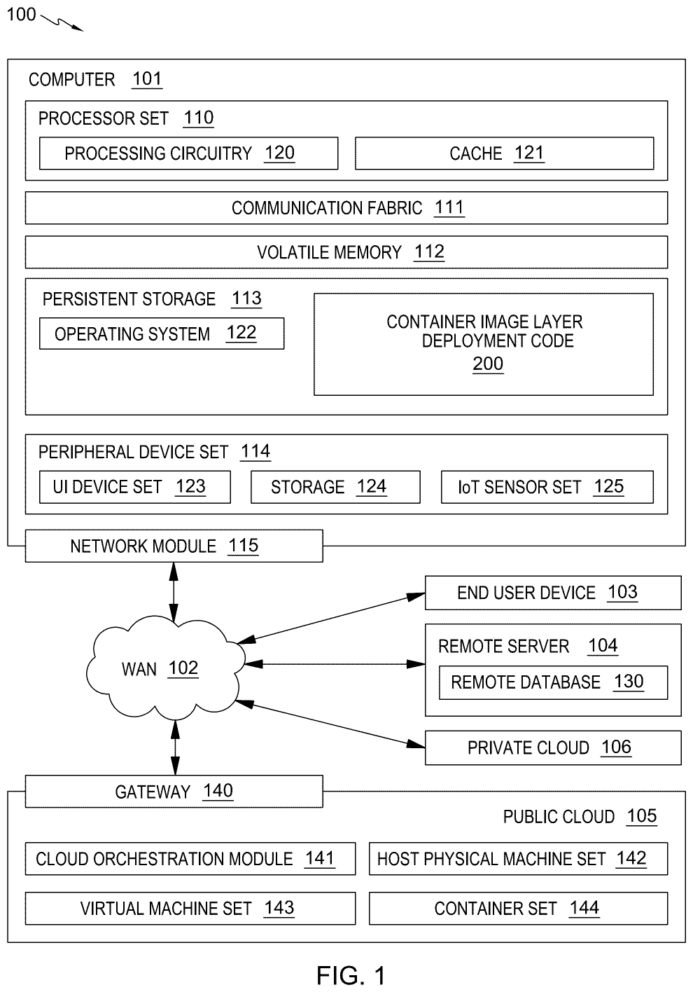

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and container image layer deployment code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as container image layer deployment code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in container image layer deployment code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 500 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

As noted, containerization is the packaging of software code, for instance, to implement a service or microservice, with dependencies, such as operating system libraries and/or other dependencies, used to run the software code to create a single, light weight executable, referred to as a container. The container is portable in that it runs consistently and reliably on any information technology (IT) infrastructure. In one or more embodiments, the software code can be an application, such as a service instance, or a microservice instance. A container is created from a container image, which is a static file that includes executable program code that can be run as an isolated process on a computing or information technology (IT) infrastructure. One image can be used to run one or more containers, which are runtime instances of the container image. Containers are lightweight (for example, they share the machine's operating system), efficient, easy to manage, secure and portable.

A variety of commercially available products exist for providing and managing containers, including open-source systems for automating deployment, scaling, and management of containerized applications. In operation, one or more of the available products can orchestrate a containerized application to run on a cluster of hosts, and automates deployment and management of cloud-native applications using on-premise infrastructure or public cloud platforms. These systems are designed to run containerized applications across a cluster of nodes (or servers or devices), which can be at a single geographical location or distributed across multiple geographical locations. In one or more implementations, a cluster is a set of nodes (whether physical computing resources or virtual computing resources) running a container agent, managed via a container orchestration control plane or platform.

Container orchestration is the automation of much of the operational effort required to generate and run containerized workloads and services. Orchestration includes a wide range of processes required to maintain a container's lifecycle, including provisioning, deployment, scaling (up and down), networking, load balancing, and more. Note that there are a variety of orchestration platforms commercially available that can be used to manage, for instance, containers and the applications, services, microservices, etc., running therein.

In one or more embodiments, a container-based computing environment can include an image-generating system and a container-running system. The image-generating system and/or container-running system can be implemented by, or executing on, a computer, such as computer 101 of computing environment 100 of FIG. 1, by way of example only. Certain embodiments of the present disclosure can include or be used in association with two phases, that is, an image-generating phase and a container-running phase.

During the image-generating phase, the image-generating system generates, in one or more embodiments, an image based on a configuration file and an existing image. In one or more implementations, an image can be built from a base image using a set of instructions or layer files. The base image can be contained in the existing image, and the instructions can be stored in the configuration file. For instance, the configuration file can be a text-based script that contains instructions for generating an image. The image generating system can read the configuration file when the generation of the image is requested, execute the instructions, and return the generated image.

Specifically, each of the instructions in the configuration file can be executed step-by-step. In execution of the instructions, an intermediate container can be created so that the instruction is run inside the intermediate container. In this way, the intermediate container can contain all changes that need to be made to the underlying layers. Then, a copy of the intermediate container can be committed to as an image. After the instructions have been executed, all of the intermediate containers can be removed and the image will be left. During the container-running phase, the container-running system can be configured to read the image in the container repository to run a container.

In one or more implementations, one or more of the instructions stored in the configuration file can create a layer file in the image. The image can contain multiple layer files which define a container image. Within the multiple layer files, a variety of software components can be included, and repeated.

Note that embodiments of the present disclosure can be embodied, in a variety of implementations, with different container-based computing environments and/or functionality. As explained further herein, pursuant to a request for an image, such as an on-demand request for an image or image layer, a container image layer deployment is established using one or more layer substitution relationships, as described further herein.

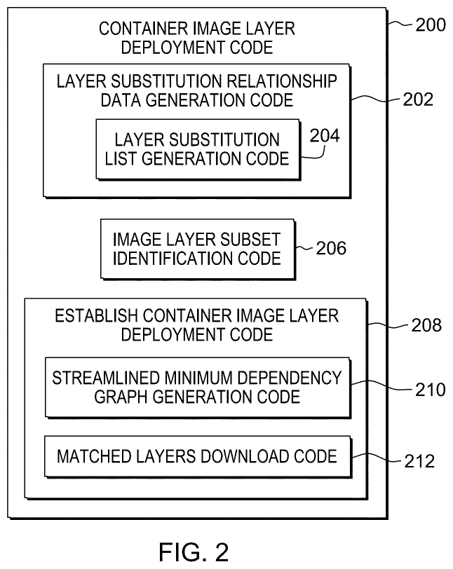

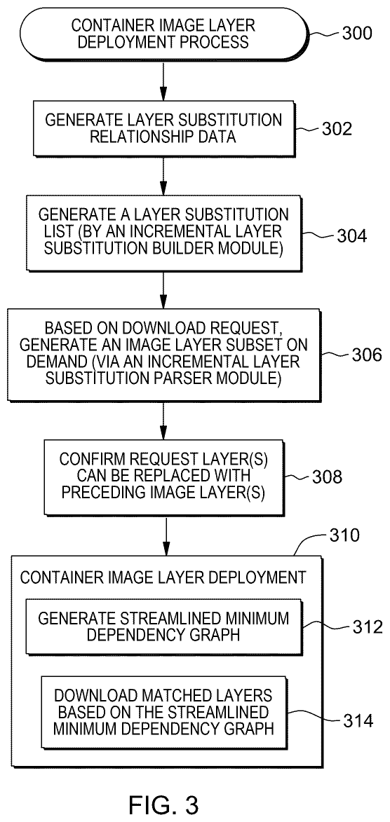

By way of example, one or more embodiments of a container image layer deployment code and workflow (in accordance with one or more aspects of the present disclosure) are described initially with reference to FIGS. 2-3. FIG. 2 depicts one embodiment of container image layer deployment code 200 that includes code or instructions to perform container image layer deployment processing, in accordance with one or more aspects of the present disclosure, and FIG. 3 depicts one embodiment of a container image layer deployment workflow, in accordance with one or more aspects of the present disclosure.

Referring initially to FIGS. 1-2, container image layer deployment code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; one or more processor sets 110 (FIG. 1); processors, such as one or more processors of processor set 110; and/or processing circuitry, such as processing circuitry of processor set 110, etc.

As noted, FIG. 2 depicts one embodiment of container image layer deployment code 200 which, in one or more implementations, includes, or facilitates, container image layer deployment processing in accordance with one or more aspects of the present disclosure. In the embodiment of FIG. 2, example code of container image layer deployment code 200 includes layer substitution relationship data generation code 202 to generate layer substitution relationship data for one or more image layers of a container image of a container-based computing environment. The layer substitution relationship data specifies one or more layer substitution relationships between different image layers of the container image. In one or more embodiments, the layer substitution relationship data generation code 202 includes layer substitution list generation code 204 to generate a layer substitution list, which is retained in, for instance, metadata of a respective image layer, to record the layer substitution relationship for that layer. In one or more embodiments, container image layer deployment code 200 further includes image layer subset identification code 206 to identify, based on a download request that specifies a target image layer of the container, an image layer subset that omits one or more superseded image layers of the container. The identifying is based, at least in part, on the generated layer substitution relationship data for the one or more layers of the container image. As described herein, in one or more embodiments, the layer substitution list can be generated by an incremental layer substitution builder module or code introduced into a graph driver of a container deployment system.

As illustrated, in one or more embodiments, container image layer deployment code 200 further includes establish container image layer deployment code 208 to establish a container image layer deployment based on the identified image layer subset, with the established container image layer deployment facilitating container processing within the container-based computing environment. In one or more embodiments, establish container image layer deployment code 208 includes streamlined minimum dependency graph generation code 210, which can build a streamlined minimum dependency graph, via (for instance) an incremental layer substitution parser module or code provided within the graph driver, during downloading of an image from the container repository. In one or more embodiments, the incremental layer substitution parser module builds the new streamlined minimum dependency graph by, for instance, parsing the one or more respective layer substitution lists and referencing one or more relational ID lists to pull the fewest number of image layers of the container required based on the download request. In one or more embodiments, establish container image layer deployment code 208 can further include matched layers download code 212 for downloading the matching layers from the container image based on the streamlined minimum dependency graph.

Note also that although various code or sub-modules are described herein, the container image layer deployment code, such as disclosed, can use, or include, additional, fewer, and/or different code/sub-modules. A particular code can include additional code, including code of other sub-modules, or less code. Further, additional and/or fewer code/sub-modules can be used. Many variations are possible.

Advantageously, the substitution-based, container image layer deployment code or process disclosed herein provides, and uses, a new relationship attribute in metadata of container image layers. The new attribute identifies the substitution relationship between, for instance, two container image layers. With this new image attribute specified, image layers can flexibly and efficiently be downloaded on demand by, for instance, determining a streamlined minimum dependency graph of image layers in which superseded image layers are replaced by superseding image layers with the latest updates, such as the latest updates to one or more files of a particular image layer. The image layer deployment code and process disclosed are convenient to use with, in one or more embodiments, a new “layer substitution” option being provided when committing images to and pulling images from the container repository. In one or more embodiments, a layer substitution list is automatically generated when the layer substitution option is specified during the layer committing process, where the layer substitution list is used, in one or more embodiments, to generate a streamlined minimum dependency graph during the image layer downloading process. In one or more embodiments, the container image layer deployment code and process disclosed allow container image layers to be pulled on demand, and at the same time the process automatically reduces the number of image layers required in order to save storage space, improve download efficiency, and ensure that the user obtains all required image layer updates. The container image layer deployment code and process disclosed herein facilitate container image deployment, and also facilitates testing groups switching to a container-working environment. Further, the container image deployment code and process disclosed are compatible with a variety of currently available container-based tools for running container-based computing environments.

In one or more embodiments, the container image layer deployment code is used, in accordance with one or more aspects of the present disclosure, to perform container image layer deployment processing. FIG. 3 depicts one example of a container image layer deployment process 300, such as disclosed herein. The process is executed, in one or more embodiments, by a computer (e.g., computer 101 (FIG. 1), and/or one or more processor sets, such as a processor or processing circuitry (e.g., of processor set 110 of FIG. 1). In one example, code or instructions implementing the process, are part of one or more code sets or modules, such as container image layer deployment code 200 of FIGS. 1-2. In other examples, the code can be included in one or more other modules and/or one or more other sub-modules of one or more other modules. Various options are available.

As illustrated in FIG. 3, in one example, container image layer deployment process 300 executing on one or more computers (e.g., computer 101 of FIG. 1), one or more processor sets (e.g., processor set 110 of FIG. 1, such as a processor or processing circuitry of the processor set) performs container image layer deployment processing such as described herein, which includes, in one or more embodiments, generating layer substitution relationship data 302. In one or more embodiments, layer substitution relationship data is generated for one or more image layers of a container image of a container-based computing environment. The layer substitution data specifies one or more layer substitution relationships between different image layers of the container image. For instance, with committing a new image layer, layer substitution relationship data can be automatically generated based on file dependencies.

In one or more embodiments, container image layer deployment process 300 further includes generating a layer substitution list 304. In one embodiment, the layer substitution list can be generated by a incremental layer substitution builder module implemented as part of the graph driver of a container deployment system, such as described further herein. In one or more embodiments, the layer substitution list can be generated for one or more image layers of the container image during the layer commit process, and be added into metadata for the respective image layer as an attribute which records the respective layer substitution relationship(s).

In one or more embodiments, container image layer deployment process 300 further includes generating on demand, based on a download request, an image layer subset 306. In one or more embodiments, the image layer subset can be generated via an incremental layer substitution parser module incorporated within the graph driver to detect, during download processing, if the image layer is superseded by parsing the respective layer substitution list(s). In one or more embodiments, container image layer deployment process 300 further includes confirming that the requested layer(s) can be replaced with an identified superseding image layer(s) 308. For instance, in one or more embodiments, the container generation system can generate a prompt to the administrator/developer/user of the system to confirm that the requested or target layer(s) can be replaced by the identified superseding image layer(s).

In one or more implementations, container image layer deployment process 300 further includes establishing a container image layer deployment 310 which can include, generating a streamlined minimum dependency graph 312, such as described herein. In one or more embodiments, the streamlined minimum dependency graph can be generated, for instance, via an incremental layer substitution parser module within the graph driver, during downloading of an image layer from the container repository. In one or more embodiments, container image layer deployment 310 can further include downloading matched layers based on the streamlined minimum dependency graph 314. For instance, in one embodiment, the incremental layer directed graph consumer pulls the least number of matching layers based on the streamlined minimum dependency graph and the specific download request for a target image layer of the container image.

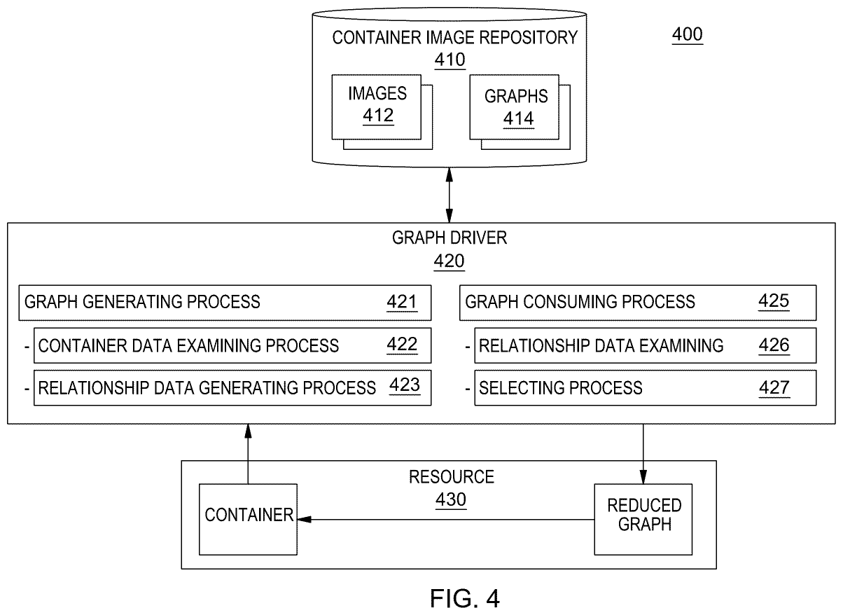

As a further example, FIG. 4 illustrates one embodiment of a container deployment system 400 which can include and/or use one or more aspects of present disclosure. In one or more embodiments, container deployment system 400 is implemented as part of, or includes, a computing environment, such as computing environment 100 described above in connection with FIG. 1. Container deployment system 400 can include a container image repository 410 in communication with a graph driver 420. Container image repository 410 can include images area 412 for storing container images and graphs area 414 for storing graphs. Graphs stored in graphs area 414 can be provided by relationship graphs that specific attributes of an associated container image of container images area 412. For respective container images in images area 412, there can be stored an associated graph in graphs area 414.

Graph driver 420, upon committing of a container image to container image repository 410, can process the container image to generate a graph representing the container image and specifying attributes of the container image. For generating a new container, graph driver 420 can process a graph of graph area 414 of container image repository 410.

In some examples, including in the architecture of FIG. 4, the program code can operate within graph driver 420. Graph driver 420 can enable a union file system. Graph driver 420 (which can be referred to as a storage driver) can be used in configuring layered container images. Further, graph driver 420 can consolidate multiple image layers into a root file system for the mount namespace of a container.

Graph driver 420 can run various processes. For instance, graph driver 420 can run graph generating process 421 in order to generate graphs for storage into graphs area 414 of container image repository 410. In one example, graph driver 420 can run graph generating process 421 responsively to committing a container image for storage of the container image into container image repository 410.

In one embodiment, graph driver 420, running graph generating process 421, can execute a container data examining process 422 for examination of container images. In one or more embodiments, the container data examining process 422 can include ascertaining an order of image layers of a container image being committed for storage into container image repository 410, identifying file dependencies of image layers of the container image being processed, and identifying abstraction layer dependencies of image layers of the subject container image being committed and submitted to container image repository 410.

Graph driver 420 running container data examining process 422 can further include running a relationship data generating process 423. Graph driver 420 running relationship data generating process 423 can include generating metadata that specifies attributes of a container image being committed into container image repository 410. The generated relationship data can define a graph for storage into graphs area 414 of container image repository 410.

In one aspect, the metadata generated by running of metadata generating process 423 can include (i) metadata provided by relationship data that specifies an ordering of image layers of a container image being committed to image repository 410, (ii) metadata provided by relationship data that specifies file dependencies of image layers of a container image being committed to container image repository 410 and (iii) metadata provided by relationship data that specifies abstraction layer dependencies of a container image being committed to image repository 410. In one or more embodiments, graph driver 420 can organize the described metadata into a tree data structure defining a relationship graph, wherein nodes of the relationship graph specify image layers of a container image being committed to container image repository 410, and wherein edges specify relationships between layers.

In one embodiment, graph driver 420 for determining submission relationships and ascertaining an ordering between image layers, can examine timestamped data that specifies a time of commitment and submission of an image layer.

For identifying file dependencies between image layers, graph driver 420 can determine whether a current image layer, and at least one other image layer modify a common file. For performing such identifying, graph driver 420 can perform container data processing, e.g., can examine text-based build file code data, text-based container image building logging data and/or text-based runtime logging data. For identifying abstraction layer dependencies between image layers, in one embodiment, graph driver 420 can examine container data, e.g., text-based build file code data, text-based container image building logging data and/or text-based runtime logging data. For identifying abstraction layer dependencies between image layers, graph driver 420 for examining one or more image layers of a container image can read a manually raised flag raised by the administrator/developer/user that predetermines and forces the identification of an abstraction layer dependency between layers.

Embodiments herein recognize that image layers of a container image can feature dependencies other than file dependencies and that if such layer dependencies are not specified, various issues can occur. Embodiments herein recognize, in part, that if an image layer is in abstraction layer dependency with a target image layer is not obtained, a user's function may be incomplete or unavailable.

In another aspect, graph driver 420 can perform graph consuming process 425. In one embodiment, graph driver 420 can run graph consuming process 425 in response to a request by a resource for an image layer. Such request can be defined by an administrator, developer or user who is using an interface in communication with the resource. In response to a resource requesting a targeted image layer of a historical container image stored in images area 412 of container image repository 410, graph driver 420 can run graph consuming process 425 to provide a reduced graph.

Graph driver 420 running graph consuming process 425 can include running container relationship data examining process 426. Graph driver 420 running container relationship data examining process 426 can include examining a certain graph of graphs area 414 of container image repository 410, wherein the certain graph subject to examining is a graph associated to a container image of images area 412 having a targeted layer targeted by a resource.

Graph driver 420 running container relationship data examining process 426 can include graph driver 420 generating a reduced graph for a resource 430, as depicted in FIG. 4. The reduced graph can reference a reduced number of image layers relative to the certain graph subject to the described examining by container relationship data examining process 426. System 400 for deployment of an application can generate a container according to the reduced graph. For generating the reduced graph, graph driver 420 can run selecting process 427. Graph driver 420 running selecting process 427 can, based on a result of the relationship data examining process 426, select a subset of referenced layers from a relationship graph associated to the repository stored container image having the targeted image layer. In one embodiment, the selected subset of layers can include the targeted layer and a subset of layers of a repository stored historical container image preceding the targeted layer.

Embodiments herein recognize that images can be distributed to provide upgraded programmatic elements. As such, when a container image is committed, in existing systems, all the contents of the image layers can be pushed to a repository, e.g., container image repository 410, in the form of a container image. When pulling a container image from the repository, in an existing system, a consumer of the image (e.g., a computing resource in a computing system) can download all the contents of the specified image layers and all parent preceding layers to a local resource. Layers can include, but are not limited to, pervasive features, high impact/pervasive program temporary fixes (HIPER) features, recommended features, new features, and a base image. Because all parent preceding layers preceding a targeted layer are uploaded and/or downloaded together, even when only certain layers are being refreshed, the download will include all parent preceding layers preceding a targeted layer. Embodiments herein recognize that the necessity in existing systems of downloading and/or uploading all parent preceding layers preceding a targeted layer increases system overhead including container deployment time.

Additionally, when only a specific package (and not all updated packages) is desired to address a particular situation (e.g., a banking customer requires an update of HIPER features to address potential outages or security issues), updating an entirety of a resource introduces risk. Embodiments herein recognize that building specific images for all customers and situations is not a scalable solution. Thus, a need exists to deploy specific (targeted) applications on-demand via container images.

Embodiments herein can provide a system and method to deploy applications on-demand through container images. Unlike existing approaches, the examples herein enable a customized and targeted deployment to fulfill specific technical needs, rather than a blanket deployment of all parent preceding image layers of a targeted image layer, as the later increases both system overhead and risk.

In some of the examples herein, program code of graph driver 420 executing on one or more processors can deploy updated services or layers on demand through containers. In embodiments herein, graph driver 420 can determine dependencies between image layers when generating and deploying containers such that a user can receive a more targeted container with current and/or interdependent layers, rather than a deployment that includes unnecessary overhead. To this end, as explained herein, graph driver 420 can analyze layers for dependencies and can group interdependent changes within the layers based on both these dependencies and on when the changes were implemented (as compared to the last image refresh of the target machine).

For example, graph driver 420 can generate a relationship graph provided by an ILDG (incremental layer directed graph) and utilize the ILDG to identify sequences of image layers (referred to herein as submissive sequences, file dependency sequences, and abstraction layer sequences) of the image layers. For determination of layer relationships, graph driver 420 can, e.g., perform monitoring the timing of uploading of image layers (e.g., timestamps), can determine files modified by an image layer, and/or can determine whether layers share data or a common resource. Graph driver 420 can deploy updated services or layers on demand through containers without including excess content in the deployments.

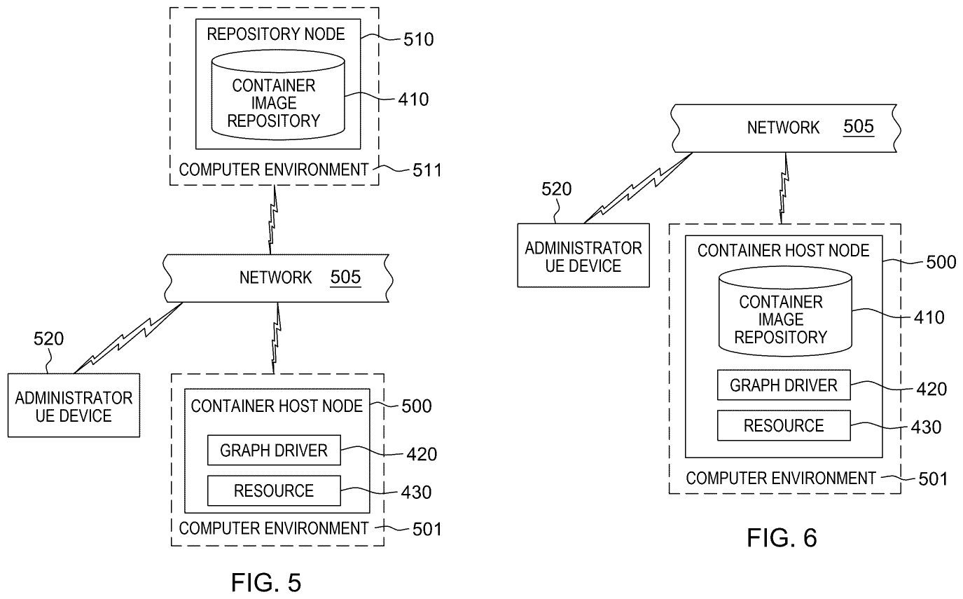

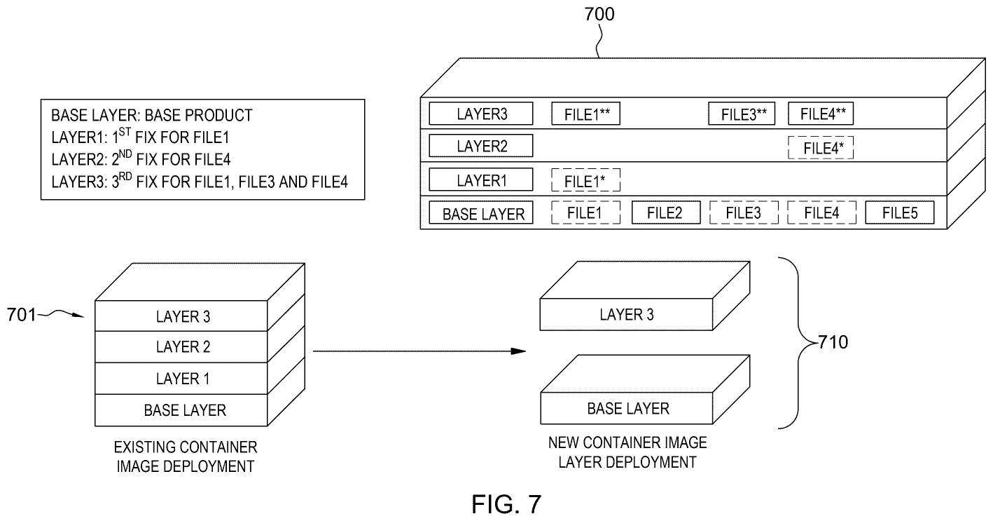

FIGS. 5 and 6 illustrate alternative infrastructure embodiments of system 400. Referring to FIG. 5, graph driver 420 can run on container host node 500 defining a container host that runs containers, and container image repository 410 can run on a repository node 510. Container host node 500 can be disposed in a first computer environment 501 and repository node 510 and be disposed in a second computer environment 511. The system can also include an administrator user equipment (UE) device 520 for use by an administrator, developer or user. UE device 520 can include or provide a user interface. The user interface can permit an administrator/developer/user to specify relationships between image layers, among other functions. Administrator UE device 520 can be configured, e.g., to permit the administrator, developer or user to configure resources to request image layers of historical container images stored in container image repository 410 and can also be configured, e.g., to permit specifying administrator, developer or user defined dependencies between image layers of a container image, in one or more embodiments.

Container host node 500, repository node 510 and administrator UE device 520 can be in communication with one another via a network 505. Network 505 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment only, computer environment 501 can be a local computing environment or otherwise private network, such as associated with an enterprise, and computer environment 511 can be a centralized computer environment, e.g., configured for access by multiple enterprises.

In one embodiment, container host node 500 can be provided by one or more computing nodes and repository node 510 can be provided by one or more computing nodes. In one or more embodiments, the described computing nodes can be physical computing nodes. In one embodiment, the one or more computing nodes of repository node 510 can be external to the one or more computing nodes of container host node 500. In one other embodiment, the one or more computing nodes of repository node 510 can be external and remote to the one or more computing nodes of the container host node 500.

In the embodiment of FIG. 6, container image repository 410 and graph driver 420 can commonly run on container host node 500 of first computer environment 501, by way of further example. Computer environment 501 can be a local or otherwise private computer environment, e.g., a private environment provided by a cloud services provider. As illustrated, the system can include administrator, developer or user equipment (UE) device 520 for use by an administrator, developer or user. UE device 520 can include a user interface. The user interface can permit an administrator, developer or user to specify relationships between image layers, among other functions. Administrator UE device 520 can also be configured, e.g., to permit configuring resources to request image layers of historical container images stored in container image repository 410, and can be configured, e.g., to permit the administrator, developer or user to specify defined dependencies between image layers of a container image in one embodiment. Container host node 500 and administrator UE device 520 can be in communication with one another via a network 505. Network 505 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. Container host node 500 can be provided by, or on, one or more computing nodes of a computer, such as computer 101 of FIG. 1.

By way of further background, open source software often encounters common vulnerabilities and exposure (CVE) issues, and the open source community will release new versions to fix CVEs frequently for one or more software products. These fixes can result in creation of new image layers in a container-based computing environment. The functions of these layer updates can include creating new files, replacing files and deleting files. Frequent creation, modification and deletion of files within image layers can create multiple additional layers for the container union file system. Even where subsequent layers completely contain the contents of previous layers, the previous layers are still typically required to be pulled through to the local server during container deployment. This results in extra processing overhead, and reduces the efficiency of the container image pulling process. In accordance with one or more aspects disclosed herein, pursuant to a request for an image layer, such as an on-demand request for a target image layer, container image layer deployment is performed using one or more layer substitution relationships.

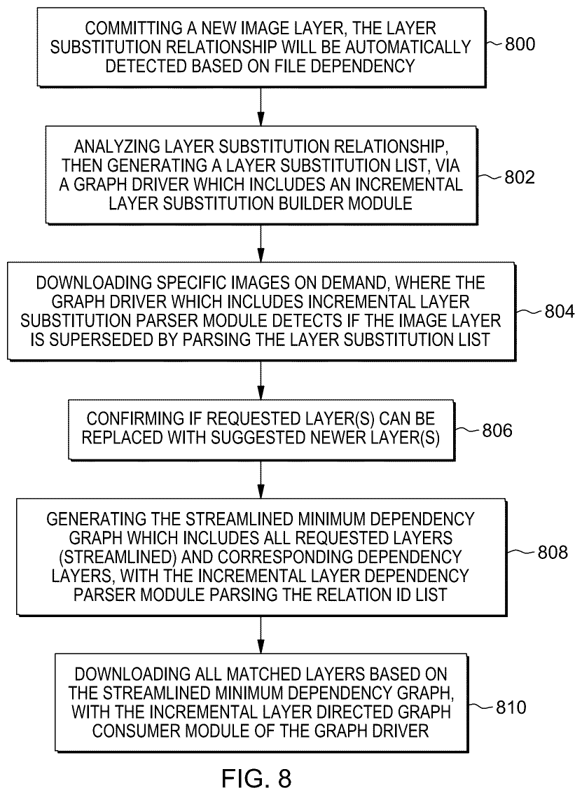

In accordance with one or more aspects, new relationship data is established and retained to identify a substitution relationship between two or more container image layers. With this new relationship data specified, container image layer deployment can proceed with greater flexibility to efficiently download image layers on-demand. In one or more embodiments, a streamlined minimum dependency graph of the container image layers is generated in which superseded image layers are replaced by superseding image layers, having the latest updates. An example of this is depicted in FIG. 7. In FIG. 7, a container union file system 700 representation is shown with a base layer, as well as a layer 1, layer 2, and layer 3, each with one or more files. In the example noted, layer 1 was uploaded with a first fix for file 1, layer 2 was uploaded for a second fix for file 4 and layer 3 was uploaded for a third fix for file 1, file 3, and file 4. Based on the container union file system mechanism, when pulling image layers for layer 3, even though file 1 and file 1* are replaced by file 1**, file 3 is replaced by file 3**, and file 4 and file 4* is replaced by file 4**, all files of the base layer, layer 1, layer 2 and layer 3 are needed to be pulled to the local environment, such as the local server, in order to execute the container 701. This leads to wasted image layer space and reduced processing efficiency. In contrast, by using a new container image layer deployment process such as described herein, only layer 3 and the base layer will need to be deployed 710.

As noted, in accordance with one or more aspects, a new relationship is defined, referred to as the substitution relationship, between two or more container image layers. With this new relationship specified, flexibility and efficiency of the download process are enhanced, as well as providing the ability to download image layers on-demand. In one or more embodiments, a streamlined minimum dependency graph image is created, based on a download request, in which superseded image layers are replaced by superseding layers with the latest updates.

In one or more embodiments, the layer substitution relationship being defined facilitates building a new type of layer dependency at the physical files level and the image layer level. For instance, by analyzing the number of files and the modification of the files in the different layers, a new relationship can be defined between two layers, for instance, L1 SUP L2, in which SUP means supersedes, L1≥L2 and L1 contains the latest updates of the same files in L2. A new attribute, referred to as the layer substitution list, for an image layer is introduced to record the layer substitution relationship. In one or more embodiments, an image layer has a single layer substitution list which, for instance, is retained as part of the metadata for the image layer. The layer substitution list can have, or identify, multiple superseded layers.

In one or more embodiments, an incremental layer substitution builder (ILSB) module is provided within the graph driver of the container deployment system, such as described herein. In one embodiment, the ILSB module includes program code that analyzes modification of the files and generates the layer substitution list for each image layer, such as during the image layer commit process. For instance, the ILSB module is executed as part of the graph driver during the committing of an image to the container repository. It generates the layer substitution list after analyzing file substitution relationship data, which is used for generating the layer substitution relationship. In addition, in one or more embodiments, an incremental layer substitution parser (ILSP) module is provided within the graph driver to parse, during pulling of an image layer from the repository, the layer substitution list together with the relation ID list to build a new graph, referred to herein as the streamlined minimum dependency graph, which makes the deployment of the updated service or layers on-demand through containers. In operation, the ILSP module includes program code to facilitate building the new streamlined minimum dependency graph in response to a download request, and pulling, for instance, the least number of matching image layers of the container image, thereby reducing processing within the container-based computing environment.

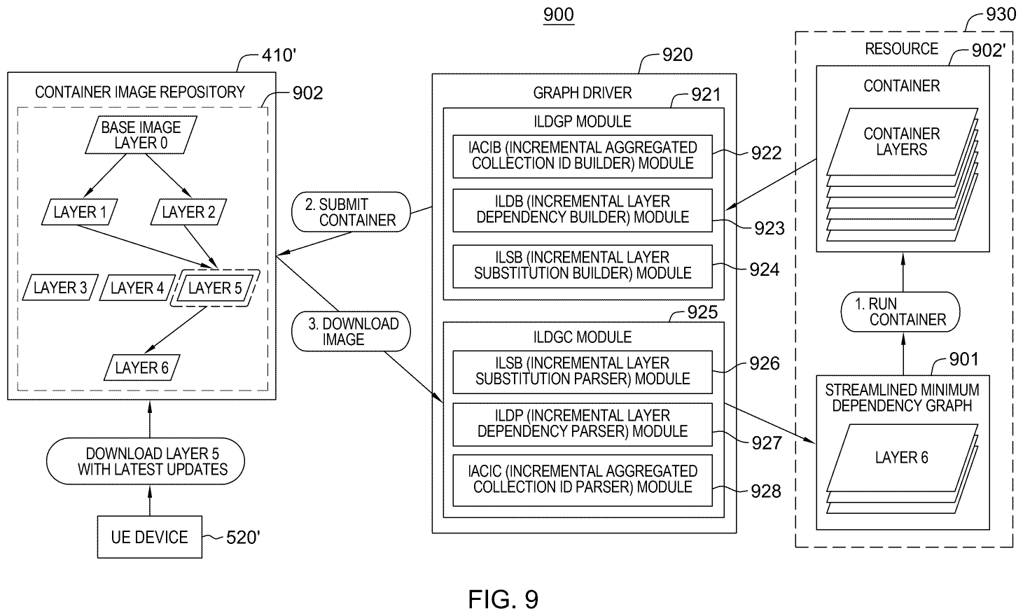

FIG. 8 depicts a further embodiment of a container image layer deployment workflow, in accordance with one or more aspects of the present disclosure. As illustrated, in one or more implementations, the workflow includes determining, with committing of a new image layer to a container image in the container repository, layer substitution relationship data. The layer substitution relationship data can be automatically detected and/or generated based on file dependency of the image layers of the container image 800.

In one or more embodiments, the workflow includes analyzing the layer substitution relationship data and generating therefrom a layer substitution list for the image layer 802. In one embodiment, the layer substitution list can be generated via the graph driver, which can include an incremental layer substitution builder module, such as described herein. As noted, the layer substitution list is a new attribute introduced to record the relevant layer substitution relationship in association with one or more (or each) image layer of the container image.

In one or more embodiments, the workflow further includes downloading one or more specific images on-demand, such as based on a download request. As noted, in one or more embodiment, the graph driver further includes an incremental layer substitution parser module with program code that detects whether a requested image layer is superseded by parsing one or more of the layer substitution lists for the respective layers of the container image 804. Based on parsing the layer substitution list and identifying one or more superseding image layers (or newer layers) to be used in place of the one or more requested layers, the container deployment system can obtain confirmation that the requested layer(s) can be replaced with the suggested superseding (and newer) layer(s) 806.

In one or more embodiments, a streamlined minimum dependency graph is generated which includes all requested layers (after streamlining) and the corresponding dependency layers, with the incremental layer dependency parser module parsing the relation ID list as part of the process 808. In one or more embodiments, the workflow further includes downloading all matched layers based on the streamlined minimum dependency graph, using, for instance, an incremental layer directed graph consumer module of the graph driver, such as described herein 810.

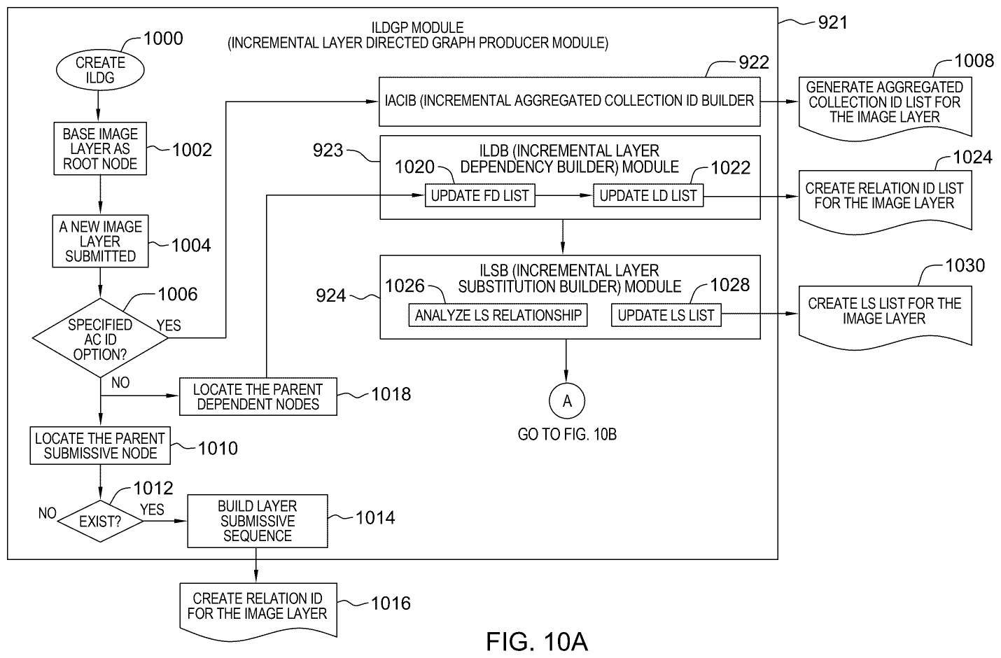

FIG. 9 depicts further details of one embodiment of a container deployment system 900 including and/or using one or more aspects of the present disclosure. In one or more embodiments, container deployment system 900 is similar to and expands upon the container deployment system 400 described above in connection with FIG. 4. In one or more embodiments, container deployment system 900 is implemented as part of, or includes, one or more computing environments, such as computing environment 100 described above in connection with FIG. 1. Container deployment system 900 includes a container image repository 410′ similar in aspects to container image repository 410 described above in connection with container deployment system 400 of FIG. 4. Container image repository 410′ can include an images area for storing container images and a graphs area for storing graphs, such as described herein. An example container image 902 is depicted in FIG. 9 with a base layer and multiple successive replacement layers, labeled layer 1 through layer 6, as an example only. In the depicted embodiment, UE device 520′ is operatively coupled within container deployment system 900 to container image repository 410′ to request download of, for instance, layer 5 with latest updates. As described herein, in one or more embodiments, a new attribute is added to the metadata of one or more image layers of container image 902. The new attribute is referred to herein as the layer substitution list attribute, which is based on the layer substitution relationships detected during committing of the particular image layer to the container image repository 410′.

As illustrated in FIG. 9, container deployment system 900 further includes a graph driver 920, similar to graph driver 420 described above in connection with a container deployment system 400 of FIG. 4. In the graph driver embodiment of FIG. 9, the driver includes graph generating program code, referred to as an incremental layer directed graph producer (ILDGP) module 921 which, in one or more embodiments, is run, for instance, during committing of a container image for storage into container image repository 410′. In one or more embodiments, the ILDGP module 921 can include an incremental aggregated collection ID builder (IACIB) module 922 to facilitate generating an aggregated collection ID list for an image layer, such as the image layer being committed to the repository. Further, graph driver 920 includes, in the depicted embodiment, an incremental layer dependency builder (ILDB) module 923, which includes code processing to create a relation ID list for the image layer from an updated file dependency (FD) list and an updated layer dependency (LD) list of the container deployment system. In one or more embodiments, the incremental layer directed graph producer module 921 further includes an incremental layer substitution builder (ILSB) module 924, such as described further herein.

In the embodiment of FIG. 9, the graph consuming process of graph driver 920 is implemented via an incremental layer directed graph consumer (ILDGC) module 925, which includes an incremental layer substitution parser (ILSB) module 926 to check the layer substitution list of an image layer and identify an image layer which supersedes the requested layer, as well as locate the upper most superseding layer, and replace the user-requested layer with the upper-most superseding layer, such as described herein. Additionally, incremental layer directed graph consumer module 925 includes, in one embodiment, an incremental layer dependency parser (ILDP) module 927 configured to check the relation ID list of the parent dependent image layer and facilitate generating the streamlined minimum dependency graph 901 in association with the data from the incremental layer substitution parser module 926. Further, the incremental layer directed graph consumer module 925 includes an incremental aggregated collection ID parser (IACIC) module 928 which, in one or more embodiments, is configured to check the aggregated collection ID list to find all matched image layers to the minimum dependency graph and collect the relation identifiers of each aggregated collection ID matched image layer.

As illustrated in FIG. 9, in one or more embodiments, container deployment system 900 facilitates providing the streamlined minimum dependency graph 901 for forwarding for running, a container 902′, with one or more container layers, on a computing resource 930, such as a local server, and/or for forwarding of the selected image layers to be deployed to the computing resource 930 pursuant to one or more resource deployment requests.

In operation, a container image can be run at (1). In response to the container image being run, graph driver 920 at (2) can commit the container image to container image repository 410′. With the committing of the container image to container image repository 410′, graph driver 920 can process the container image to generate relationship graphs and layer substitution lists for storage into container image repository 410′, as described herein. At (3) a computing resource 930 can request selective download of a certain image layer of a certain container image. In response to the request, graph driver 920 can run the noted graph consuming process to return a streamlined minimum dependency graph 901 from which the container can be established, such as described herein.

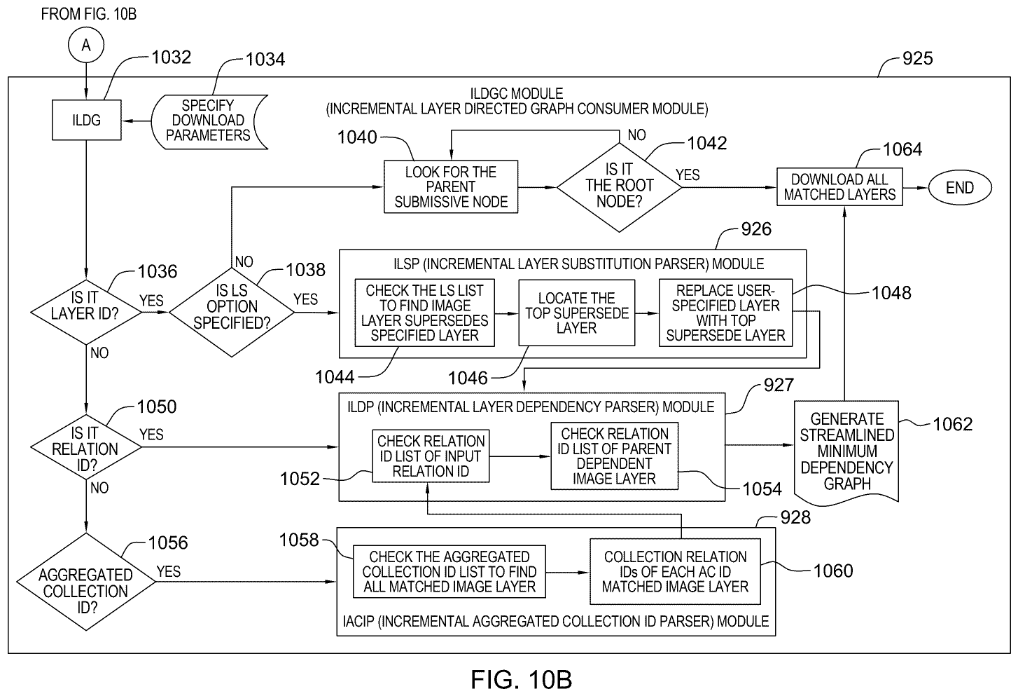

FIGS. 10A-10B depict one embodiment of a workflow that illustrates various further aspects of graph driver 920 of container deployment system 900 of FIG. 9. As described herein, the workflow defines and/or generates the dependencies between image layers to facilitate, for instance, deploying an image layer and/or container. For ease of understanding, various aspects are separated into first and second modules, referred to herein as the incremental layer directed graph producer (ILDGP) module 921 (FIGS. 9-10A) and the incremental layer directed graph consumer (ILDGC) module 925 (FIGS. 9 & 10B), but this is merely one configuration embodiment of graph driver 920, in accordance with one or more aspects of the present disclosure.

In some embodiments, graph driver 900 (FIG. 9) running the incremental layer directed graph producer (ILDGP) module 921 generates, in part, an incremental layer directed graph (ILDG) (e.g., directed graph) or any other structure in which dependencies between image layers can be represented 1000. To generate the ILDG (or similar structure), graph driver 900 (FIG. 9) sets the base layer image as root node 1002. Graph driver 900 can obtain a submission of a given image layer 1004 for committing to the container image. In order to generate the ILDG, graph driver 900 can evaluate each image layer in turn. FIGS. 10A-10B illustrate the graph driver 900 (FIG. 9) ILDGP module 921 workflow in evaluating a given layer. Graph driver 920 repeats the illustrated workflow to evaluate each layer based on the order of submission of the layers. In one or more embodiments, one or more processes of the workflow can be performed concurrently, such as with a submission of each new layer defining a container image into the container repository or can be performed layer by layer based on time order of submission after all layers for the container image have been uploaded in the container image repository. In one or more embodiments, time stamps can be analyzed that specify submission times of respective layers defining a container image.

In the workflow of FIGS. 10A-10B, upon submission of a new image layer, the graph driver determines whether the aggregated collection (AC) ID option is specified 1006. If “yes”, then the workflow can proceed to the incremental aggregated collection ID builder (IACIB) module 922 code to generate the aggregated collection ID list for the image layer 1008.

Assuming that the AC ID option is not specified, then upon submission of the layer, the graph driver workflow can locate a parent submissive layer or node 1010, and if a parent submissive layer is determined to exist 1012, the graph drive can proceed to build a layer submissive sequence 1014. To mark the submissive sequence, the graph driver generates a relation ID for the newly submitted image layer 1016. For instance, the graph driver can calculate a relation ID for each layer by submitting all the ancestor submissive layers' image IDs through a hash algorithm (e.g., SHA256). For example, relation_ID_{L5}=SHA256 (Image_ID_{LB}+Image_ID_{L1}+ . . . +Image_ID_{L4}).

The graph driver, while examining incoming submitted layers for time submission relationships, can also or alternatively, be examining incoming submitted layers for file dependencies and/or abstraction layer dependencies for use as described herein.

The graph driver, in examining submitted layers for file dependencies, can ascertain whether a submitted layer modifies a common file with the submitted layer. The graph driver examining the submitted layers for abstraction layer dependencies can, for instance, process container data to ascertain that a submitted layer and another layer communicate and share data with one another or can, for instance, process container data to ascertain that a submitted layer and another layer use common resources. The graph driver examining the submitted layers for abstraction layer dependencies can include the graph driver examining an image layer and ascertaining that a user has raised a manually defined flag associated with the image layer, so that the identification of an abstraction layer dependency is predetermined and forced.

Referring to FIG. 10A, the graph driver further locates the parent dependent layers or nodes 1018 and executes the incremental layer dependency builder (ILDB) module 923 to, for instance, update the file dependency (FD) list 1020 and update the layer dependency (LD) list 1022, which are used to create the relation ID list for the image layer 1024. For instance, in one or more embodiments, the graph driver examines the container data to ascertain whether a submitted layer is in file dependency with its immediate parent layer. Based on being in file dependency with the immediate parent layer, the graph driver can add a relation ID for the parent layer into the file dependency (FD) list for the submitted layer. The graph driver, on determining that the submitted image layer does not have a parent dependent layer, can designate this submitted layer as a file dependency dependent child of the root layer (i.e., base layer). Embodiments recognize that each layer of the container stores changed content, and downloading a certain layer with the base layer can provide assurance that the complete functionality of the certain layer can be provided. Therefore, each layer can be in file dependency relation to the base layer.

Further, in one or more embodiments, the graph driver workflow can determine whether there is an abstraction layer dependency in the current submitted layer, either upon determining that the submitted layer is not file dependent on another layer or on providing an FD list for the submitted layer. For instance, the graph driver can examine the container data to ascertain whether a submitted layer is in abstraction layer dependency with its immediate parent layer (or can identify an abstraction layer dependency based on reading a manually raised software flag raised by an administrator, developer or user to predetermine and force the identification of an abstraction layer dependency). Based on the graph driver ascertaining that a submitted layer is an abstraction layer dependency with its parent layer, the graph driver can add a relation ID for the parent layer into an abstraction layer dependency (LD) list for the submitted layer. As noted, upon completion of these updates, the graph driver can generate a cumulative dependency list of layers from the FD list and the LD list, which is referred to herein as the cumulative dependency relation ID list (or alternatively termed the relation ID list). The cumulative dependency relation ID list for the submitted layer can include references (relation IDs) for layer references on either of the FD list or the LD list for the submitted layer.

In one or more embodiments, the graph driver can remove duplicate references to a certain layer that are referenced on both the FD list and the LD list for the submitted layer.

In one or more embodiments, the graph driver workflow further executes the incremental layer substitution builder (ILSB) module code to perform processes such as described herein, including analyzing the files in the layer to determine if the layer contains all the files or updated files of other layers, for instance, to determine whether the image layer supersedes one or more other image layers 1026. In addition, the executing program code determines whether the image layer supersedes one or more other layers based on analyzing the layer substitution data, and if so, updates the layer substitution list attribute of the image layer 1028. As a result of the processing, a layer substitution (LS) list attribute is created and retained in metadata for the image layer for future parsing, such as described herein 1030.

As noted, FIG. 10B depicts one embodiment of processes implemented by the graph driver in executing incremental layer directed graph consumer module 925, which (in one or more embodiments) consumes the relational graphs/data produced by the process of FIG. 10A. Where the process of FIG. 10A depicts an ILDGB module that specifies operations of the graph/data generating process, in one embodiment, FIG. 10B depicts an ILDCG module that specifies operation of the graph/data consuming process, in one embodiment.

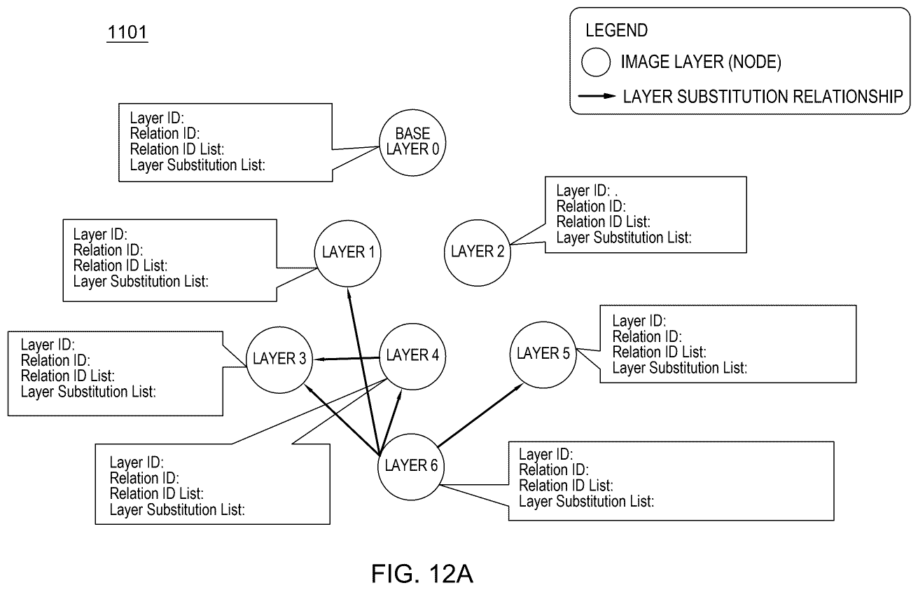

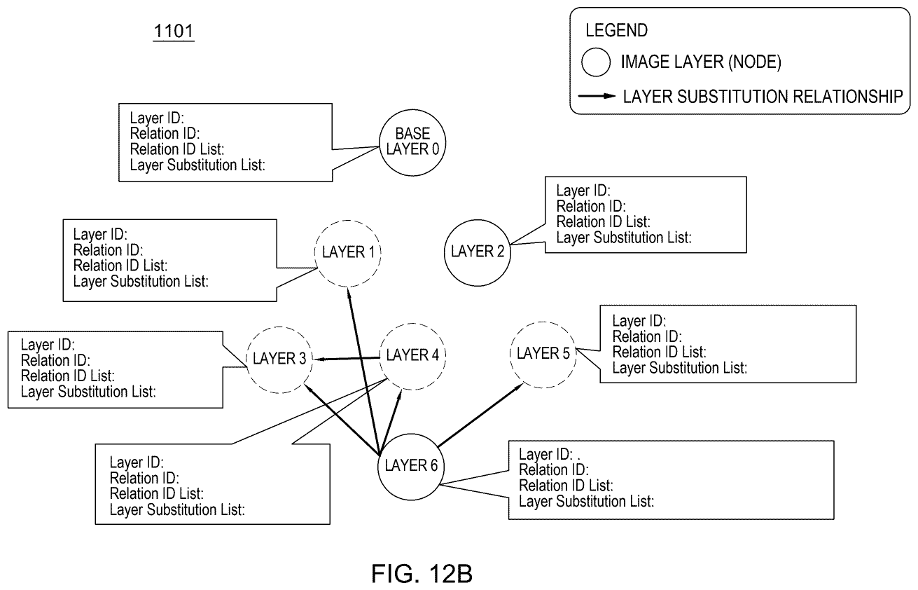

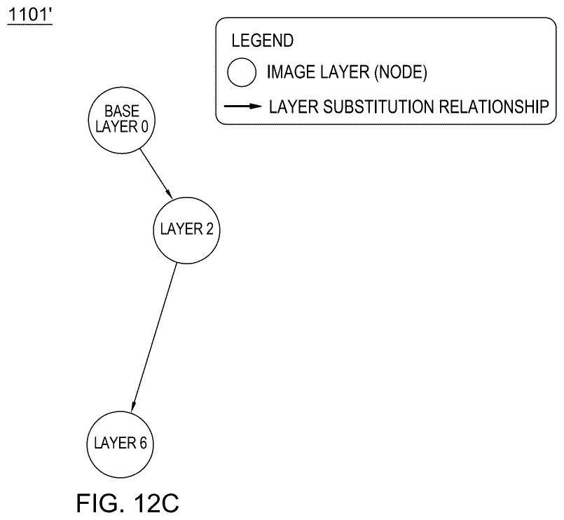

As illustrated in FIG. 10B, the graph driver, running the ILDCG module 925 code, can produce a relationship graph or incremental layer directed graph (ILDG) 1032, an example which is depicted in FIG. 12A, and described below. The graph driver running the incremental layer directed graph module code can also obtain download parameters from a resource of a computing system, where the parameters can include a request for elements, including a request for a given image layer 1034. In one embodiment, the specified download parameters can be parsed for identification of a layer ID. If the download option specified by, for instance, an end user, is a layer ID 1036, then processing determines whether the layer substitution option is specified 1038. If “no”, then the executing graph driver program code can look for a parent submissive layer or node with the attribute “image layers list” 1040. Further, the program code can determine whether the particular image layer is the root node, that is, whether the base layer has been found 1042. In one or more embodiments, processing can also identify a time submissive sequence of all submitted layers as part of this analysis.

In one or more embodiments, where the layer substitution option is specified 1038, then the incremental layer substitution parser module 926 is run to check the layer substitution list to find all image layers that supersede this particular image layer 1044. From all the image layers that supersede this image layer, processing determines the top superseding layer 1046, and then replaces the user specified image layer with the top superseding image layer 1048.

In one or more embodiments, for parsed parameters that are not layer IDs, graph driver processing determines whether the parameters include a relation ID 1050. That is, the processing determines whether the download option specified in the download parameters is a relation ID. If “yes”, then processing runs the incremental layer dependency parser (ILDP) module 927. In one or more embodiments, this includes the graph driver analyzing the relation ID list of the input relation ID 1052 to, for instance, obtain a complete identification of the file and/or abstraction layer dependencies. Further, the processing checks the relation ID list of the parent dependent image layer 1054 to facilitate generating the streamlined minimum dependency graph 1062 from both the relation ID data and the layer substitution list data, such as described herein. In particular, the streamlined minimum dependency graph, in one or more embodiments, contains all aggregated collection (AC) ID layers, and dependency layers, with one or more layers replaced by top, superseding layers.

In one or more embodiments, the incremental layer directed graph consumer (ILDGC) module 925 can further determine, when executing, whether the downloaded parameters specify an aggregated collection (AC) ID 1056. If “yes”, then processing checks the aggregated collection ID list to determine all matched image layers 1058 and among the matching layers (AC ID Match) processing collects the relation IDs 1060 to facilitate further dependency processing, such as described herein.

In one or more embodiments, the executing ILDGC module code 925 further downloads all matched layers 1064 using, for instance, the base node layer 1042 and the generated streamlined minimum dependency graph 1062, such as described herein.

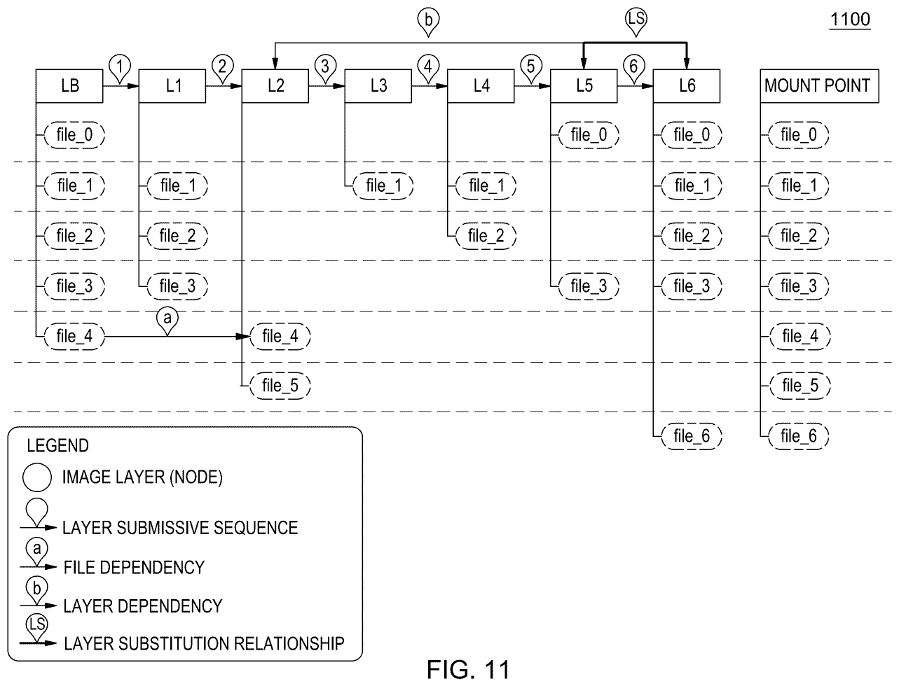

As described, in one or more embodiments, there are three relationship attributes defined, generated and used in accordance with the container image layer deployment processing disclosed herein. FIG. 11 depicts an exemplary container image file set 1100 which includes a base layer (LB), layer 1 (L1), layer 2 (L2), layer 3 (L3), layer 4 (L4), layer 5 (L5), and layer 6 (L6). As illustrated in FIG. 11, file dependency data is used to record the file dependency of different image layers. In the example of FIG. 11, a modification to the same file results in a file dependency, such as illustrated in FIG. 11 between layer 2, file 4 and the base layer, file 4.

The layer dependency relationship records dependencies between different image layers. This includes developer-specified dependencies, but are not limited to that. In FIG. 11, a layer dependency is demonstrated between layer 5 (L5) and layer 2 (L2), by way of example.

Additionally, a layer substitution relationship is also defined and generated to establish a new type of layer dependency at the physical files level and image layer level. This new relationship is referred to as a layer substitution relationship. With this relationship defined, layers that are superseded will be ignored when pulling an image from the repository, and the number of image layers pulled, for instance, pursuant to a download request, will be reduced. In the example of FIG. 11, by analyzing the number of files and modifications to the files, it is determined that L6 SUP L5, L6≥L5 and L6 contains the latest updates of (at least) the same files in layer 5 (L5). More particularly, in one or more embodiments, the layer substitution relationship can be defined by the following: If set A∩set B=set B or set A∪set B=set A, then we define there is a layer substitution relationship between Layer A and Layer B (i.e., Layer A SUPed (superseded) Layer B). To ensure the accuracy of a layer substitution relationship, a comparison technique is used to provide the difference between files to the user, which allows the user to determine whether this modification contains functional updates. According to FIG. 11, the set of files for each layer is shown below:

$$L 6 = \{ file\_ 0 , file\_ 1 , file\_ 2 , file\_ 3 , file\_ 6 \}$$

$$L 5 = \{ file\_ 0 , file\_ 3 \}$$

$$L 4 = \{ file\_ 1 , file\_ 2 \}$$

$$L 3 = \{ file\_ 1 \}$$

$$L 2 = \{ file\_ 4 , file\_ 5 \}$$

$$L 1 = \{ file\_ 1 , file\_ 2 , file\_ 3 \}$$

$$L 0 = \{ file\_ 0 , file\_ 1 , file\_ 2 , file\_ 3 , file\_ 4 \}$$

$$Take L 6 for example : L 6 ⋂ L 5 = L 5 , L 6 ⋂ L 4 = L 4 , L 6 ⋂ L 3 = L 3 ,$$

$$L 6 ⋂ L 1 = L 1 , i . e . , L 6 SUPed ( superseded ) L5 , L 4 , L 3 , and L 1.$$

In one or more embodiments, the layer substitution list (LS list) is introduced as a new field or attribute in the metadata for an image layer to record the relation ID of the layer that has a layer substitution relationship with the current layer. In one or more embodiments, an image layer has a single LS list. The LS list can have multiple superseded layers' relation ID. The layer substitution list is then used as an input for generating the respective streamlined minimum dependency graph.

By way of example, FIGS. 12A-12B depict one embodiment of a relationship graph 1101 built by the graph driver using the container image example of FIG. 11. In the example illustrated, each layer or node in the graph has associated therewith attributes or fields including a layer ID, relation ID, relation ID list, and a layer substitution list, in one or more embodiments. Note in this example that it is assumed that layer 1 was committed to after the base layer, and accordingly is time submissive to the base layer. Layer 2 was committed after layer 1, etc., with layer 6 being the most recent layer. In one or more embodiments, for each layer identified for a plurality of layers defined in a container image, the graph driver records a layer ID and a relationship ID. With each image layer being assigned a unique image identifier, layer ID, and also assigned a relation ID. In one or more embodiments, a relation ID of a root layer (base layer) can be the same as its layer ID. A relation ID can uniquely match and identify an image layer. As illustrated, there can be recorded for each node or layer, a layer ID and a relation ID. Relation IDs for a sequence of layers can be used to verify the integrity of a download of a set of layers. In one or more embodiments, the graph driver can record relationship data in the form of time submission relation sequences for layers determined to have time submission relationships. Time submission sequences can include a current layer, and a sequence of layers identified as having time submission relationships back to the base layer. The graph driver can record relation IDs to facilitate identification of a sequence of time submission related layers. As described, the attributes associated with each known layer can further include a file dependencies list and a layer dependencies list. The file dependencies refer to any file dependencies between any layers of a container image subject to uploading, and the layer dependencies list can be an abstraction layer dependency list to specify abstraction layer dependencies. Such an LD list for a certain layer can include the relation ID for each layer determined to be a direct abstraction layer dependency with the certain layer. By query of a LD list of a given layer, and by iteratively querying LD lists of preceding layers in abstraction dependency with the query layer back to the base layer, the graph driver can return a sequence of layers in abstraction dependency relation, where the sequence includes one or more than one preceding layers.

In addition, in one or more embodiments, the incremental layer substitution builder module code disclosed herein defines and generates the new layer substitution list attribute that is added to the metadata of each image layer. For instance, in the examples of FIGS. 12A-12B, it is known that 1.6 ∩L5=L5, L6∩L4=L4, L6∩L3=L3, L6∩L1=L1 SUPs (supersedes) L5, L4, L3 and L1, so layer substitution list of L6 contains relation IDs . . . (L1) . . . (L3) . . . (L4) and . . . (L5). As noted, the relation ID list records the unique IDs of all images that have dependencies with the particular image.

FIG. 12B depicts an exemplary embodiment where a user has requested download of layer L5 (where L5 is superseded by L6). In this case, the incremental layer substitution parser module recommends that the user pull layer 6 (L6). Assuming that the user agrees to download the replacement layer, the requested layer(s) (replaced and streamlined) and the corresponding dependency layers will be pulled or downloaded to the local computing resource.

An exemplary streamlined minimum dependency graph 1101′ is depicted in FIG. 12C, which is dynamically generated based on the layer substitution list (and other metadata, relation ID list) of the requested layer during pulling of the image from the container repository. Note that, in this example, layer 1 (L1) and layer 5 (L5) are superseded by layer 6 (L6). Therefore, they are not needed during pulling of the container image from the repository, as represented by the streamlined minimum dependency graph 1101′ of FIG. 12C.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
generating layer substitution relationship data for one or more image layers of a container image of a container-based computing environment, the layer substitution relationship data specifying one or more layer substitution relationships between different image layers of the container image;
based on a download request that specifies a target image layer of the container image, identifying an image layer subset that omits one or more superseded image layers of the container image, the identifying being based, at least in part, on the generated layer substitution relationship data for the one or more image layers of the container image; and
establishing a container image layer deployment based on the identified image layer subset to facilitate container processing within the container-based computing environment.

2. The computer-implemented method of claim 1, wherein the image layer subset contains a superseding image layer to the target image layer, the one or more superseded image layers of the container omitted from the image layer subset including the target image layer.

3. The computer-implemented method of claim 1, further comprising generating a streamlined minimum dependency graph identifying a minimum number of image layers for the container image layer deployment based on the target image layer specified in the download request and a substitution relationship between at least two image layers of the container, the identifying the image layer subset comprising generating the image layer subset from a minimum number of image layers for the container image layer deployment and the substitution relationship between the at least two image layers of the container.

4. The computer-implemented method of claim 1, wherein the generated layer substitution relationship data comprises a layer substitution list in metadata of a superseding image layer to the target image layer, the layer substitution list identifying the target image layer as being replaced by the superseding image layer.

5. The computer-implemented method of claim 1, wherein generating the layer substitution data comprises generating and retaining, for multiple image layers of the container, a respective layer substitution list in associated metadata of each image layer of the multiple image layers of the container.

6. The computer-implemented method of claim 1, wherein the generating comprises generating, during a committing of a superseding image layer to the container image in a container repository of the container-based computing environment, a layer substitution list based on analysis of one or more file substitution relationships between layers of the container image, the superseding image layer superseding, at least in part, the target image layer.

7. The computer-implemented method of claim 6, further comprising using, based on the download request, at least the layer substitution list of the superseding image layer together with a relation ID list in building, based on the target image layer specified in the download request, a streamlined minimum dependency graph identifying a minimum number of image layers for the container image layer deployment.

8. The computer-implemented method of claim 7, wherein the establishing includes using the streamlined minimum dependency graph in establishing the container image layer deployment pursuant to the download request.

9. The computer-implemented method of claim 1, wherein establishing the container image layer deployment results in deployment of a reduced count of layers of the container image pursuant to the download request.

10. A computer program product for facilitating processing within a computing environment, the computer program product comprising:
a set of one or more computer readable storage media; and
program instructions, collectively stored in the set of one or more storage media, for causing at least one processor set to perform computer operations comprising:
generating layer substitution relationship data for one or more image layers of a container image of a container-based computing environment, the layer substitution relationship data specifying one or more layer substitution relationships between different image layers of the container image;
based on a download request that specifies a target image layer of the container image, identifying an image layer subset that omits one or more superseded image layers of the container image, the identifying being based, at least in part, on the generated layer substitution relationship data for the one or more image layers of the container image; and
establishing a container image layer deployment based on the identified image layer subset to facilitate container processing within the container-based computing environment.

11. The computer program product of claim 10, wherein the image layer subset contains a superseding image layer to the target image layer, the one or more superseded image layers of the container omitted from the image layer subset including the target image layer.

12. The computer program product of claim 10, further comprising generating a streamlined minimum dependency graph identifying a minimum number of image layers for the container image layer deployment based on the target image layer specified in the download request and a substitution relationship between at least two image layers of the container, the identifying the image layer subset comprising generating the image layer subset from a minimum number of image layers for the container image layer deployment and the substitution relationship between the at least two image layers of the container.

13. The computer program product of claim 10, wherein the generated layer substitution relationship data comprises a layer substitution list in metadata of a superseding image layer to the target image layer, the layer substitution list identifying the target image layer as being replaced by the superseding image layer.

14. The computer program product of claim 10, wherein the generating comprises generating, during a committing of a superseding image layer to the container image in a container repository of the container-based computing environment, a layer substitution list based on analysis of one or more file substitution relationships between layers of the container image, the superseding image layer superseding, at least in part, the target image layer.

15. The computer program product of claim 14, further comprising using, based on the download request, at least the layer substitution list of the superseding image layer together with a relation ID list in building, based on the target image layer specified in the download request, a streamlined minimum dependency graph identifying a minimum number of image layers for the container image layer deployment.

16. The computer program product of claim 15, wherein the establishing includes using the streamlined minimum dependency graph in establishing the container image layer deployment pursuant to the download request.

17. A computer system comprising:
at least one processor set;
a set of one or more computer-readable storage media; and
program instructions, collectively stored in the set of one or more storage media, for causing the at least one processor set to perform computer operations comprising:
generating layer substitution relationship data for one or more image layers of a container image of a container-based computing environment, the layer substitution relationship data specifying one or more layer substitution relationships between different image layers of the container image;
based on a download request that specifies a target image layer of the container image, identifying an image layer subset that omits one or more superseded image layers of the container image, the identifying being based, at least in part, on the generated layer substitution relationship data for the one or more image layers of the container image; and
establishing a container image layer deployment based on the identified image layer subset to facilitate container processing within the container-based computing environment.

18. The computer system of claim 17, wherein the image layer subset contains a superseding image layer to the target image layer, the one or more superseded image layers of the container omitted from the image layer subset including the target image layer.

19. The computer system of claim 17, further comprising generating a streamlined minimum dependency graph identifying a minimum number of image layers for the container image layer deployment based on the target image layer specified in the download request and a substitution relationship between at least two image layers of the container, the identifying the image layer subset comprising generating the image layer subset from a minimum number of image layers for the container image layer deployment and the substitution relationship between the at least two image layers of the container.

20. The computer system of claim 17, wherein the generating comprises generating, during a committing of a superseding image layer to the container image in a container repository of the container-based computing environment, a layer substitution list based on analysis of one or more file substitution relationships between layers of the container image, the superseding image layer superseding, at least in part, the target image layer.
